(19) United States
(12) Patent Application Publication
(10) Pub. No.: US 2012/0140330 A1
(43) Pub. Date: Jun. 7, 2012

(54) LENS BARREL DEVICE AND IMAGING APPARATUS

(75) Inventors: Tatsuyuki NAKAYAMA, Kanagawa (JP); Hideharu MIYAGAKI, Kanagawa (JP); Tomohiro YASUI, Tokyo (JP); Junya SATO, Kanagawa (JP); Yusuke HOSOMI, Kanagawa (JP)

(73) Assignee: Sony Corporation, Tokyo (JP)

(21) Appl. No.: 13/302,100

(22) Filed: Nov. 22, 2011

(30) Foreign Application Priority Data
Dec. 1, 2010 (JP) 2010-268742

(51) Int. Cl. G02B 7/20; G02B 7/02

(52) U.S. Cl. 359/601

(57) ABSTRACT

A lens barrel device that configures a lens barrel supporting an optical system includes: a first lens barrel; a second lens barrel that moves in a direction of an optical axis with respect to the first lens barrel in accordance with rotation of the first lens barrel around the optical axis of the optical system; and a light shielding member that is disposed so as to block a gap between the second lens barrel and the first lens barrel.

### FIELD

The present disclosure relates to a lens barrel device in which a plurality of lens barrels are housed as a nested type and are configured to be able to be taken in and out in the direction of an optical axis and a gap between adjacent lens barrels is light-shielded by a light shielding member and an imaging apparatus including the lens barrel device.

### BACKGROUND

As an imaging apparatus of this type in the related art, for example, there is an imaging apparatus as disclosed in JP-A-2005-308888. In JP-A-2005-308888, a retractable lens barrel and an imaging apparatus are disclosed. The retractable lens barrel disclosed in JP-A-2005-308888 includes a plurality of lens barrels that can move relatively and a photographing optical system, at least two lens holding frames, and guide mechanisms and driving mechanisms corresponding to the lens holding frames. The plurality of lens barrels have different outer diameters and are configured so as to be relatively movable in the axial direction on the axis, and the photographing optical system is arranged inside the plurality of lens barrels. The photographing optical system includes at least two lens holding frames arranged so as to be aligned in the direction of the optical axis, and a lens holding frame positioned on the rearmost side out of the lens holding frames and a lens holding frame positioned on the right front side thereof are supported by corresponding guiding mechanisms so as to be movable in the direction of the optical axis. In addition, the lens holding frame positioned on the rearmost side and the lens holding frame positioned on the right front side thereof are configured to move in the direction of the optical axis by corresponding driving mechanisms. Furthermore, the driving mechanism that moves the lens holding frame positioned on the rearmost side in the direction of the optical axis includes a movement part that is driven by a motor so as to move linearly along the direction of the optical axis.

In addition, the lens holding frame, which is positioned on the rearmost side, of the retractable lens barrel according to JP-A-2005-308888 is biased to the front side by a coil spring, and an engagement part disposed in the lens holding frame is brought into contact with the movement part from the rear side. Furthermore, the lens holding frame positioned on the rearmost side is arranged so as to move in the direction of the optical axis in accordance with the linear movement of the movement part. In addition, in a retracted state in which the plurality of lens barrels are shortest, the lens holding frame positioned on the rearmost side is located at the rear end position that is located on the rearmost side by the driving mechanism. The lens holding frame positioned on the front side is moved to the rear side by the driving mechanism and is brought into contact with the lens holding frame positioned on the rearmost side that is located at the rear end position and then moves to the rear side together with the lens holding frame positioned on the rearmost side so as to be located at the rear end position at which the movement part and the engagement part are separated from each other.

### SUMMARY

However, in the above-described retractable lens barrel in the related art, the plurality of lens barrels have a configuration in which a predetermined gap is arranged between the lens barrels and they are fitted together as a nested type. Although it is necessary to arrange the gap between the lens barrels so as to allow the inner and outer lens barrels to move relatively, external light enters the inside of the lens barrels through the gap. Thus, it is necessary to prevent light transmitted from the outside from entering the inside of the lens barrels except for a portion of the inside of the lens barrels through which light from a subject is transmitted in the photographing optical system. Accordingly, generally, a light shielding member formed in a ring shape is arranged, the light shielding member is attached to the cross-section of the lens barrel positioned on the outer side, and the gap between the lens barrels positioned on the inner side and the outer side is blocked, whereby external light is prevented from entering the inside of the lens barrels.

The light shielding member is formed from a material such as paper or rubber, and, in order to improve the light shielding property by using the light shielding member, it is necessary to configure the size of the inner diameter of the lens barrel to be smaller than that of the outer diameter of the lens barrel positioned on the inner side so as to allow press fitting. Generally, the light shielding member is fixed to the cross-sectional part of the outer lens barrel, a decorative ring is mounted in the inner lens barrel, and the inner circumferential side of the light shielding member is configured to be slidably brought into contact with the outer circumferential face of the decorative ring. Accordingly, in a case where the light shielding member is configured so as to allow press fitting, when two lens barrels move relatively, a strong frictional force is generated between the light shielding member and the decorative ring. As a result, the sliding load of an electric motor as a driving source of the lens barrels increases, and there is a problem in that it is necessary to increase the size of the electric motor. Furthermore, a sound is generated in accordance with the sliding contact between the light shielding member and the decorative ring, and the sound increases in proportion to an increase in the sliding load so as to cause generation of a noise.

In a lens barrel device in the related art, although a light shielding member is arranged so as to prevent light from entering the inside of the lens barrels through the gap between the lens barrels, the light shielding member is bonded and fixed to the cross-section of the lens barrel, and the inner circumferential side is configured to be brought into tight contact with the decorative ring. Accordingly, in a case where the size of the light shielding member is configured to allow press fitting so as to increase the light shielding property, the sliding frictional force between the light shielding member and the decorative ring increases, whereby it is necessary to increase the size of the driving motor. Furthermore, there is also a problem in that a noise is generated in accordance with the sliding contact between the light shielding member and the decorative ring.

An embodiment of the present disclosure is directed to a lens barrel device that configures a lens barrel supporting an optical system. The lens barrel device includes: a first lens barrel; a second lens barrel that moves in a direction of an optical axis with respect to the first lens barrel in accordance with rotation of the first lens barrel around the optical axis of the optical system; and a light shielding member that is disposed so as to block a gap between the second lens barrel and the first lens barrel. The light shielding member is formed by an elastic member and has one or more light shielding member-side convex portions or light shielding member-side concave portions, which can be engaged with a lens barrel-side concave portion or a lens barrel-side convex portion that is disposed in the first lens barrel, disposed therein. Through engagement between the one or more light shielding member-side convex portions or the light shielding member-side concave portions and the lens barrel-side concave portion or the lens barrel-side convex portion, the light shielding member can move with respect to the first lens barrel in a direction perpendicular to the optical axis of the optical system and is linked with the first lens barrel in a direction of rotation around the optical axis.

Another embodiment of the present disclosure is directed to an imaging apparatus including: a lens barrel device which includes a plurality of lens barrels, in which an optical system is arranged, and the plurality of lens barrels are housed as a nested type so as to be able to move relatively in an axial direction; and an imaging apparatus main body to which the lens barrel device is attached. The lens barrel device includes a first lens barrel, a second lens barrel that moves in a direction of an optical axis with respect to the first lens barrel in accordance with rotation of the first lens barrel around the optical axis of the optical system, and a light shielding member that is disposed so as to block a gap between the second lens barrel and the first lens barrel. The light shielding member is formed by an elastic member and has one or more light shielding member-side convex portions or light shielding member-side concave portions, which can be engaged with a lens barrel-side concave portion or a lens barrel-side convex portion that is disposed in the first lens barrel, disposed therein. Through engagement between the one or more light shielding member-side convex portions or the light shielding member-side concave portions and the lens barrel-side concave portion or the lens barrel-side convex portion, the light shielding member can move with respect to the first lens barrel in a direction perpendicular to the optical axis of the optical system and is linked with the first lens barrel in a direction of rotation around the optical axis.

According to the lens barrel device and the imaging apparatus according to the embodiments of the present disclosure, the light shielding member is formed by an elastic member, and one or more light shielding member-side convex portions or light shielding member-side concave portions are arranged and are configured so as to be able to be engaged with a lens barrel-side concave portion or a lens barrel-side convex portion that is disposed in the first lens barrel or the second lens barrel. Accordingly, even in a case where the center of the light shielding member that shields light by blocking the gap between the first lens barrel and the second lens barrel deviates from the optical axis of the optical system, and the sliding frictional force of the light shielding member due to relative rotation locally increases, the light shielding member moves in the radial direction so as to decrease the deviation of the frictional force. In addition, the light shielding member is rotated around the first lens barrel or the second lens barrel by one or more light shielding member-side convex portions or the light shielding member-side concave portions, and accordingly, external light can be prevented from entering the inside of the barrels. Therefore, an increase in the sliding frictional force of the light shielding member is prevented while the light shielding property is secured by the light shielding member, whereby the load of the operating load can be decreased.

### BRIEF DESCRIPTION OF THE DRAWINGS

FIG. 1 is a perspective view illustrating a lens barrel device according to a first embodiment of the present disclosure.

FIG. 2 is a front view of the lens barrel device illustrated in FIG. 1.

FIG. 3 is a schematic diagram illustrating the lens barrel device, which is cross-sectioned along the optical axis of a photographing optical system, illustrated in FIG. 1.

FIG. 4 is a schematic diagram illustrating a main portion of the lens barrel device shown in FIG. 3 in an enlarged scale.

FIG. 5 is a perspective view of a linear motion ring, a cam ring, a light shielding member, and a decorative ring of the lens barrel device illustrated in FIG. 1.

FIG. 6 is a front view of a light shielding member illustrated in FIG. 4.

FIGS. 7A and 7B are cross-sectional views of the light shielding member illustrated in FIG. 6. FIG. 7A is a cross-sectional view taken along line X-X illustrated in FIG. 6, and FIG. 7B is a cross-sectional view taken along line Y-Y illustrated in FIG. 6.

FIG. 8 is a schematic diagram illustrating the sliding contact state between a light shielding member and a lens barrel of the lens barrel device illustrated in FIG. 1.

FIGS. 9A and 9B illustrate a light shielding member of a lens barrel device according to a second embodiment of the present disclosure. FIG. 9A is a front view, and FIG. 9B is a rear view.

FIGS. 10A and 10B illustrate a light shielding member of a lens barrel device according to a third embodiment of the present disclosure. FIG. 10A is a front view, and FIG. 10B is a rear view.

FIGS. 11A and 11B illustrate a light shielding member of a lens barrel device according to a fourth embodiment of the present disclosure. FIG. 11A is a front view, and FIG. 11B is a cross-sectional view illustrating the state of being engaged with a lens barrel.

FIGS. 12A and 12B illustrate a light shielding member of a lens barrel device according to a fifth embodiment of the present disclosure. FIG. 12A is a front view, and FIG. 12B is a cross-sectional view illustrating the state of being engaged with a lens barrel.

FIGS. 13A and 13B illustrate a light shielding member of a lens barrel device according to a sixth embodiment of the present disclosure. FIG. 13A is a front view, and FIG. 13B is a cross-sectional view illustrating the state of being engaged with a lens barrel.

FIGS. 14A and 14B illustrate a light shielding member of a lens barrel device according to a seventh embodiment of the present disclosure. FIG. 14A is a front view, and FIG. 14B is a cross-sectional view illustrating the state of being engaged with a lens barrel.

FIG. 15 is a schematic diagram illustrating a second example of a lens barrel device according to an embodiment of the present disclosure.

FIGS. 16A and 16B illustrate an example of a light shielding member of the lens barrel device illustrated in FIG. 15. FIG. 16A is a front view, and FIG. 16B is a schematic diagram illustrating the state of being engaged with a lens barrel.

FIG. 17 is a perspective view of a digital camera illustrating a first example of an imaging apparatus using a lens barrel device according to an embodiment of the present disclosure.

### DETAILED DESCRIPTION

A light shielding member is formed by an elastic member, the light shielding member is supported by a first lens barrel or a second lens barrel so as to be movable in a direction perpendicular to the optical axis of an optical system, and one or more convex portions or concave portions are disposed in the light shielding member so as to be configured to rotate along with the first lens barrel or the second lens barrel. Accordingly, a gap formed between the first lens barrel and the second lens barrel is closed by the light shielding member so as to secure the light shielding property, and, even in a case where the amount of eccentricity of the light shielding member with respect to the optical axis is large, the light shielding member can be prevented from being let out in the radial direction so as to increase the sliding frictional force locally. Therefore, a local increase in the sliding frictional force is prevented while the light shielding property of the gap between the first lens barrel and the second lens barrel is sufficiently secured, whereby an increase in the size of the driving source can be prevented.

### EMBODIMENTS

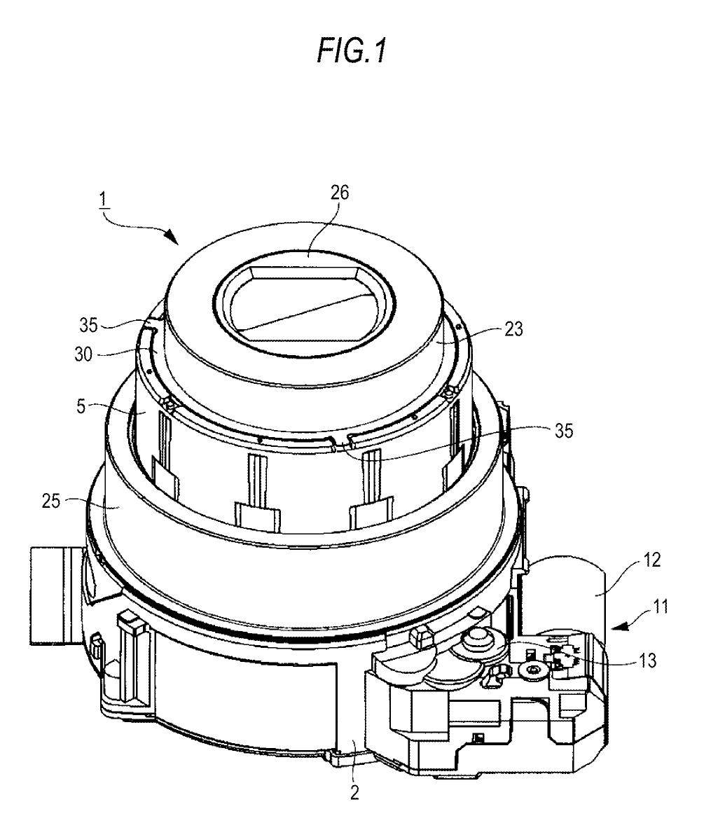

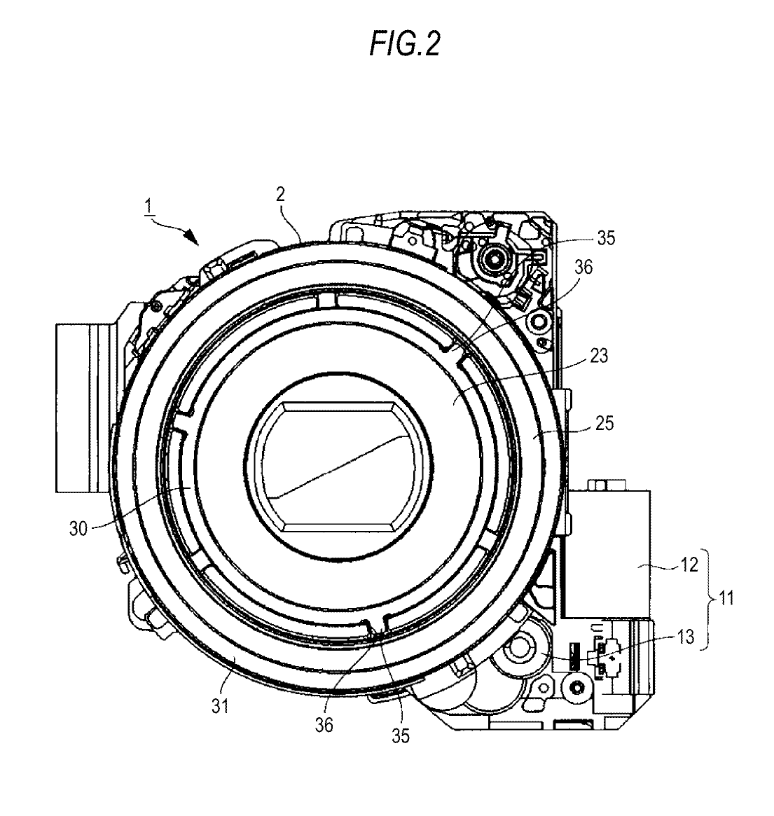

FIGS. 1 to 3 illustrate an example of a lens barrel device according to an embodiment of the present disclosure, and the lens barrel device is a retractable lens device 1 that is configured as a nested type in which six lens barrels project on three levels. This retractable lens device 1 is configured so as to include six lens barrels formed in a cylindrical shape with different diameters, that is, a fixed ring 2, a rotary ring 3, a linear motion cam ring 4, a cam ring 5, a linear motion ring 6, and a first group frame 7. The lengths of the six lens barrels in the axial direction are set to approximately the same level.

The rotary ring 3 is fitted into the inside of the fixed ring 2 having the largest diameter so as to be relatively movable, the linear motion cam ring 4 is fitted into the inside of the rotary ring 3 so as to be relatively movable, and the cam ring 5 is fitted into the inside of the linear motion cam ring 4 so as to be relatively movable. In addition, the linear motion ring 6 is fitted into the inside of the cam ring 5 so as to be relatively movable, the first group frame 7 is fitted into the inside of the linear motion ring 6 so as to be relatively movable, and a first group lens holding frame 8 is fixed to the first group frame 7. A first group lens 9 that is configured by a combination of a plurality of lenses is bonded to the first lens group holding frame 8 by using an adhesive so as to be integrally fixed thereto.

On a side opposite to the subject side of the first group lens 9 on the optical axis, a second group lens and a third group lens, which are not shown in the figure, an imaging device, and the like are arranged. There are cases where a fourth group lens, a fifth group, and the like are included in the first to third group lenses as necessary. In addition, there are cases where an infrared filter and other optical components are included in the imaging device and the like. The optical system of the retractable lens device 1 is configured by the first to third group lenses, the imaging device, and the like. Accordingly, the optical axis CL of the optical system coincides with the optical axis of the first group lens 9. As the imaging device, for example, a CCD (Charge Coupled Device) or CMOS (Complementary Metal Oxide Semiconductor) image sensor or the like can be used.

On the inner circumferential face of the fixed ring 2, a spiral groove used for rotating the rotary ring 3 around the optical axis CL and a linear motion groove used for linearly moving the linear motion cam ring 4 along the optical axis CL are disposed. In addition, in the fixed ring 2, a power generating unit 11 used for an extending or contracting operation of the retractable lens device 1 is disposed. The power generating unit 11 includes an electric motor 12 and a power transfer gear train 13 that increases the rotational force by decelerating the rotation of the rotary axis of the electric motor 12 and transfers the rotational force to the rotary ring 3. Although the relative movement of the linear motion cam ring 4 with respect to the rotary ring 3 in the direction of the optical axis is restricted, the linear motion cam ring 4 is supported to be rotatable in the direction of rotation.

Accordingly, by operating the power generating unit 11 so as to transfer the rotational force to the rotary ring 3, the rotary ring 3 is driven to rotate. At this time, the rotary ring 3 is guided to the spiral groove arranged on the inner circumferential face of the fixed ring 2 and moves in the direction of the optical axis while rotating around the optical axis CL. In contrast to this, although the linear motion cam ring 4 is in a freely movable state with respect to the rotary ring 3 in the direction of rotation, the relative movement thereof with respect to the rotary ring 3 in the direction of the optical axis is blocked. On the other hand, the linear motion cam ring 4 is guided by the linear motion groove disposed on the inner circumferential face of the fixed ring 2 and can move linearly only in the direction of the optical axis CL. Accordingly, when the rotational force is transferred from the power generating unit 11 to the rotary ring 3, the rotary ring 3 moves in the direction of the optical axis in accordance with the amount of driving generated by the power generating unit 11 while rotating around the optical axis CL. At this time, since the rotational operation of the linear motion cam ring 4 is blocked by the fixed ring 2, the linear motion cam ring 4 does not rotate but moves linearly in the direction of the optical axis by the same distance as that of the rotary ring 3.

In the linear motion cam ring 4, a spiral groove 15 is disposed which is used for moving the cam ring 5 in the direction of the optical axis while rotating the cam ring 5. A guide pin 16 disposed in the cam ring 5 is engaged with the spiral groove 15 so as to be slidable. The guide pin 16 of the cam ring 5 is engaged also with the linear motion groove disposed in the rotary ring 3, and the cam ring 5 can move relatively with respect to the rotary ring 3 in the direction of the optical axis by being guided by the linear motion groove. The linear motion ring 6 is supported by the cam ring 5 so as to be freely rotatable in a state in which the relative movement thereof in the direction of the optical axis is blocked. On the inner circumferential face of the cam ring 5, a cam groove 17 that is used for moving the first group frame 7 in the direction of the optical axis is disposed. In addition, the linear motion ring 6 can move linearly in the direction of the optical axis in a state in which the linear motion ring 6 is guided by the linear motion groove disposed in the linear motion cam ring 4, and the rotation thereof is blocked.

Accordingly, by driving the rotary ring 3 to rotate, the cam ring 5 is driven to rotate around the optical axis CL in the same direction in accordance with the amount of rotation of the rotary ring 3. Simultaneously with this operation, the linear motion cam ring 4 moves linearly in the direction of the optical axis in accordance with the amount of rotation of the rotary ring 3, and accordingly, the cam ring 5 also moves in the direction of the optical axis in accordance with the amount of movement of the linear motion cam ring 4. At this time, since the rotary operation of the linear motion ring 6 is blocked by the linear motion cam ring 4, the linear motion ring 6 does not rotate but moves linearly in the direction of the optical axis by the same distance as that of the cam ring 5.

In addition, in the linear motion ring 6, a linear motion groove 18 that extends in parallel with the optical axis CL is disposed. An engagement pin 21 disposed in the first group frame 7 is engaged with the linear motion groove 18 so as to be slidable.

The engagement pin 21 of the first group frame 7 passes through the linear motion groove 18 of the linear motion ring 6 and is simultaneously engaged with the cam groove 17 of the cam ring 5 as well. As a result, by rotating the cam ring 5, the first group frame 7 does not rotate but moves linearly in the direction of the optical axis. In other words, when the cam ring 5 rotates, the engagement pin 21 of the first group frame 7 moves along the cam groove 17. However, since the engagement pin 21 is simultaneously engaged with the linear motion groove 18 of the linear motion ring 6 as well, the rotational operation of the first group frame 7 is prevented by the linear motion groove 18, and the first group frame 7 only moves in the direction of the optical axis.

The operations of the six lens barrels can be summarized as follows.

### 1) Fixed Ring 2

The fixed ring 2 is fixed to the camera main body and performs neither a rotary operation nor a linear motion.

### 2) Rotary Ring 3

The rotary ring 3 performs a rotary operation and a linear motion.

### 3) Linear Motion Cam Ring 4

The linear motion cam ring 4 performs not a rotary operation but a linear motion only.

### 4) Cam Ring 5

The cam ring 5 performs a rotary operation and a linear motion.

### 5) Linear Motion Ring 6

The linear motion ring 6 performs not a rotary operation but a linear motion only.

### 6) First Group Frame 7

The first group frame 7 performs not a rotary operation but a linear motion only.

Through such operations of the six lens barrels, the first group lens 9 and the second and third group lenses not shown in the figure move in the direction of the optical axis CL, whereby a focusing operation for a subject is performed.

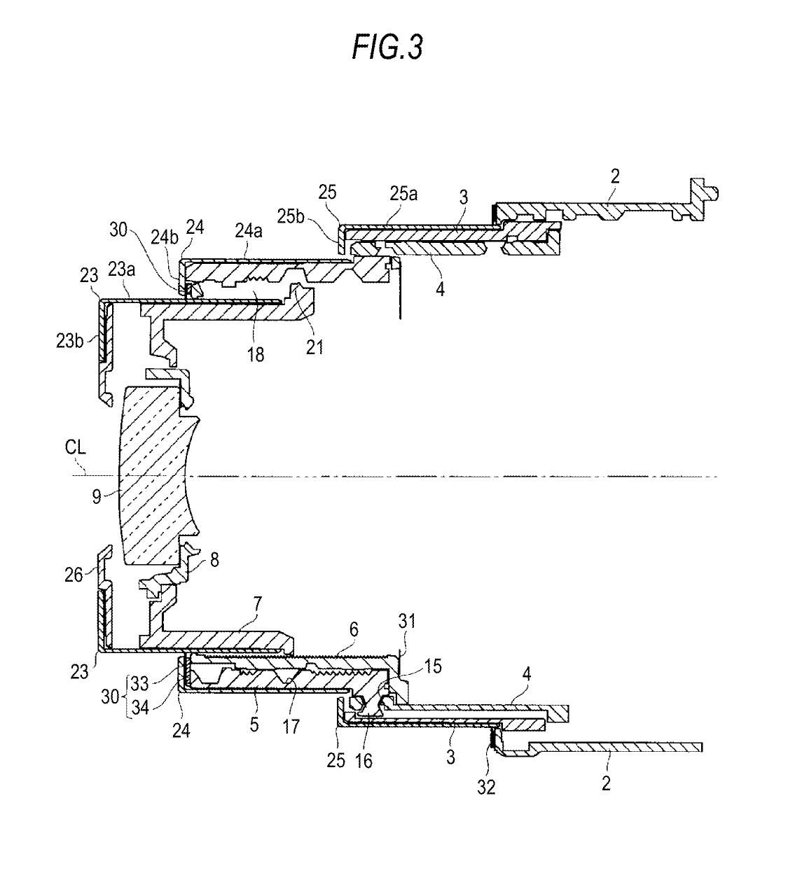

As illustrated in FIG. 3, a decorative ring A23 is mounted in the first group frame 7, a decorative ring B24 is mounted in the cam ring 5, and a decorative ring C25 is mounted in the rotary ring 3. Although the main object of using the decorative rings A23 to C25 is to improve the design, that is, to achieve the improvement of the external view of the exterior of the retractable lens device, it can contribute also to the improvement of the light shielding capability as described later.

All the decorative rings A23 to C25 are configured by cylindrical parts 23a, 24a, and 25a and cross-sectional parts 23b, 24b, and 25b that are continuous to one end of each of the cylindrical parts 23a to 25a and form inward flange shapes expanded toward the inner side in the radial direction. The cylindrical part 23a of the decorative ring A23 is formed so as to have a size fitted to the first group frame 7, and the cross-sectional part 23b thereof extends up to a position near the first group lens 9 in parallel with the cross-sectional part of the first group frame 7. To the inner side of the cross-sectional part 23b, a barrier cover 26 is arranged and is fixed to the inner face of the cross-sectional part 23b by using an adhesive so as to be integrally configured. In addition, an iris mechanism, which is not shown in the figure, used for adjusting the amount of light transmitted through a lens group such as the first group lens 9 is housed between the first group frame 7 and the barrier cover 26 inside the decorative ring A23.

The cylindrical part 24a of the decorative ring B24 is formed so as to have a size fitting to the cam ring 5, and the inner diameter of the cross-sectional part 24b is formed to be slightly larger than the outer diameter of the cylindrical part 23a of the decorative ring A23. In addition, the cylindrical part 25a of the decorative ring C25 is formed so as to have a size fitting to the rotary ring 3, and the inner diameter of the cross-sectional part 25b is formed to be slightly larger than the outer diameter of the cylindrical part 24a of the decorative ring B24. When the retractable lens device 1 is retracted, in other words, in a state in which the thickness in the direction of the optical axis is the thinnest, the cross-sectional parts 23b to 25b of the three decorative rings A23 to C25 are arranged on approximately the same plane. On the other hand, when the retractable lens device 1 is extended, the cross-sectional parts 23b to 25b are in a state of being closest to the end portions of the cylindrical parts 23a to 25a that are opposite to the cross-sectional parts 23b to 25b thereof.

In such a case, between the outer circumferential face of the cylindrical part and the inner circumferential edge of the cross-sectional part of the decorative rings that are adjacent to each other, it is necessary to form a gap for securing relative movement thereof, and there is a concern that external light penetrates into the inside of the lens barrel from the gap. Accordingly, in this embodiment, a light shielding member 30 is disposed between the cam ring 5 that represents a specific example of the first lens barrel and the first group frame 7 that represents a specific example of the second lens barrel, a light shielding member A31 is disposed between the linear motion ring 6 and the first group frame 7, and a light shielding member B32 is disposed between the fixed ring 2 and the rotary ring 3.

The light shielding member A31 and the light shielding member B32 are similar to those used in the related art and are formed in a ring shape by using rubber, paper, or the like. The light shielding member A31 is bonded so as to be fixed to the rear end face of the linear motion ring 6, and the inner edge thereof can be brought into contact with the rear end face of the first group frame 7. In addition, the light shielding member B32 is bonded so as to be fixed to the tip end face of the fixed ring 2 by using an adhesive, and the inner circumferential edge thereof can be slid in contact with the outer circumferential face of the decorative ring C25. Since the inside of the lens barrel has a labyrinth structure, the gap between the fixed ring 2 and the rotary ring 3 has a structure of which it is difficult for light to penetrate into the inside, and accordingly, a sufficient light shielding property can be acquired by only bringing the inner circumferential edge of the light shielding member B32 into contact with the decorative ring C25.

In addition, a light shielding member is not disposed between the rotary ring 3 and the cam ring 5. The reason for this is that, although there is a gap between the rotary ring 3 and the cam ring 5, the inside of the gap is covered with a part of the linear motion ring 6, and there is no concern that external light penetrates into the inside.

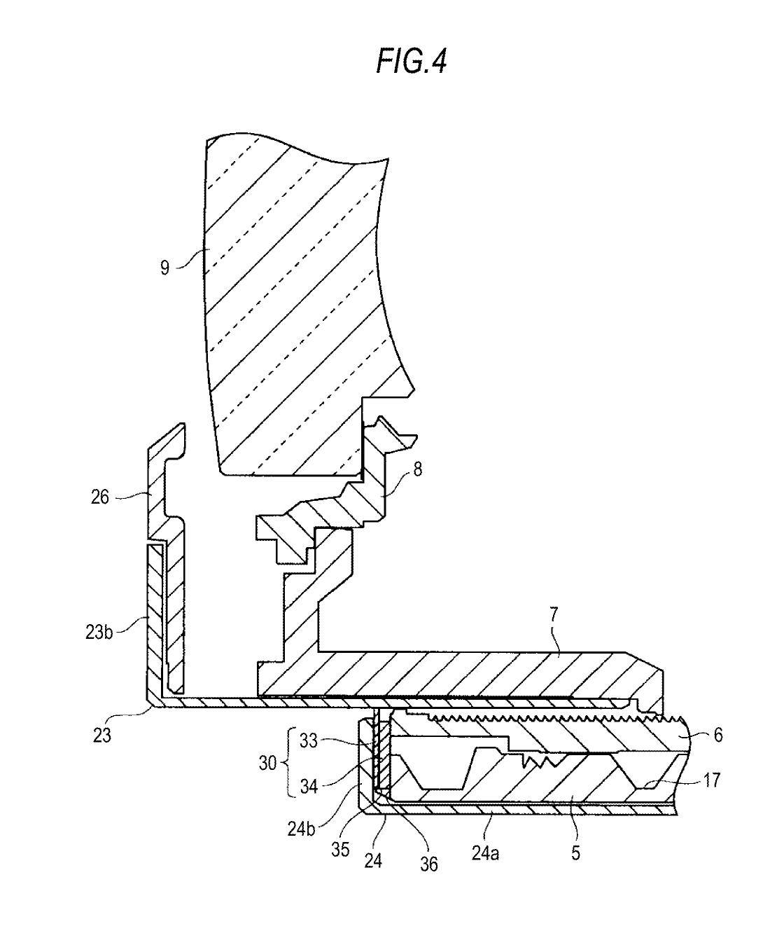

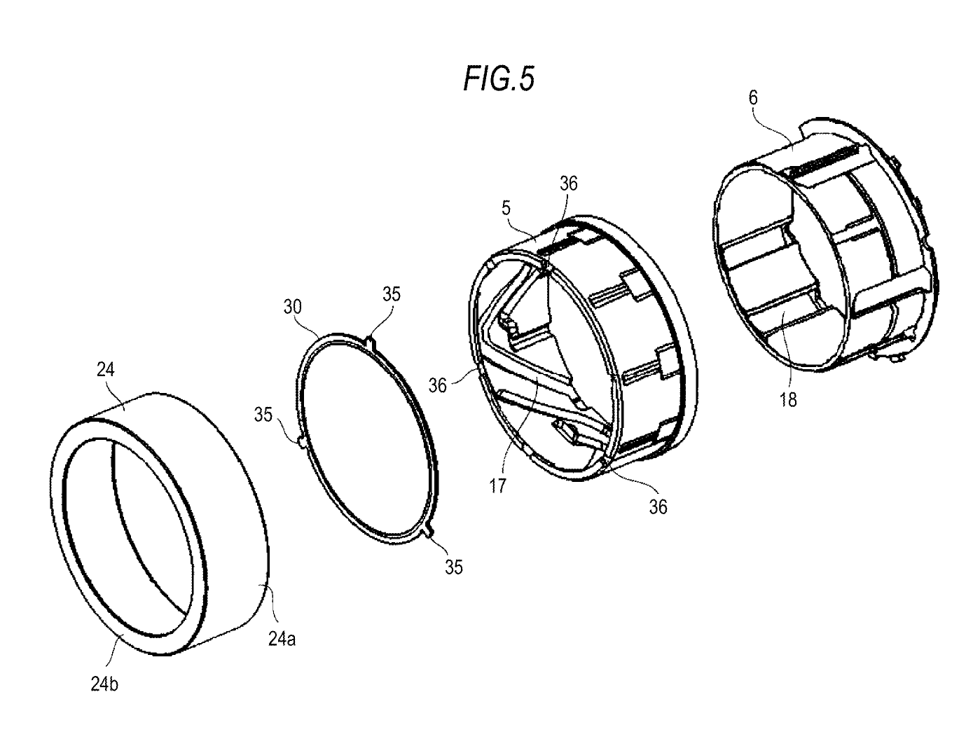

The light shielding member 30 has a shape and a structure as illustrated in FIGS. 4 to 7. In other words, the light shielding member 30 represents a light shielding member of a retractable lens device 1 according to a first embodiment of the present disclosure and is configured by a light shielding portion 33 formed in a ring shape by an elastic member and a reinforcing portion 34 that reinforces the strength of the light shielding portion 33. In the light shielding member 30, three light shielding member-side convex portions 35 to 35 protruding to the outer side of the radial direction are disposed, and the three light shielding member-side convex portions 35 to 35 are arranged so as to be equally spaced in the circumferential direction. The three light shielding member-side convex portions 35 to 35 are arranged such that the light shielding member 30 rotates with being linked with the rotation operation of the cam ring 5.

This light shielding member 30, as illustrated in FIGS. 3 and 4 with its main part represented in an enlarged scale, is arranged so as to cover the front end face (the end face of the subject side) of the linear motion ring 6, and the three light shielding member-side convex portions 35 as a part thereof is configured to protrude to the cam ring 5 side so as to be engaged with three lens barrel-side concave portions. Most of the light shielding member 30 is covered with the cross-sectional part 24b of the decorative ring B24, and a portion that is exposed to the inner side in the radial direction from the inner circumferential end of the cross-sectional part 24b is configured so as to slide on the outer circumferential face of the decorative ring A23 with being in contact therewith.

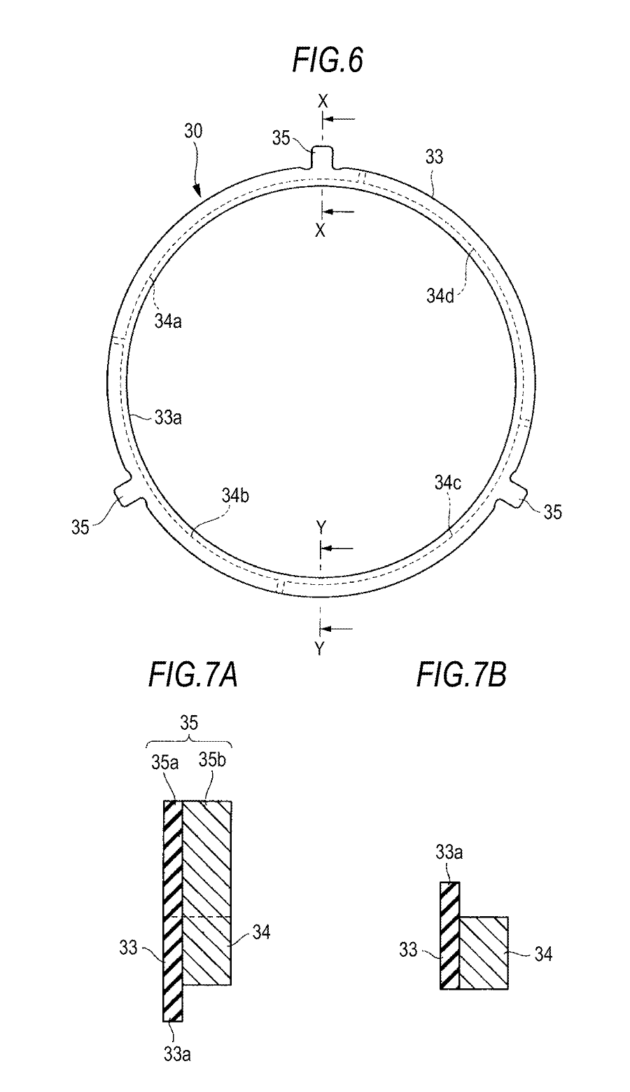

As illustrated in FIG. 6 and FIGS. 7A and 7B, the light shielding portion 33 of the light shielding member 30 is formed in a ring shape by an elastic member such as rubber that can be easily expanded or contracted. As specific examples of the rubber described here, there are acrylic rubber, silicon rubber, a butyl rubber, a fluorine-containing rubber, and the like. It is apparent that other various kinds of rubber can be used. At three positions on the outer circumferential edge of the light shielding portion 33, three light shielding member-side protrusions 35a to 35a protruding to the outer side in the radial direction are disposed.

The inner diameter of the light shielding portion 33 is formed to be slightly smaller than the outer diameter of the decorative ring A23. Accordingly, the inner circumferential edge of the light shielding portion 33 is configured so as to be brought into contact with the outer circumferential face of the decorative ring A23 in a state of being slightly pressed thereto. In addition, the outer diameter of the light shielding portion 33 is formed so as to have approximately the same size as the outer diameter of the linear motion ring 6. The diameter of a circle binding the tip ends of the three light shielding member-side protrusions 35a to 35a is formed so as to have approximately the same size as the outer diameter of the cam ring 5.

The reinforcing portion 34 of the light shielding member 30 is configured by a combination of four division parts 34a, 34b, 34c, and 34d that are acquired by dividing the light shielding portion 33 in the circumferential direction into four. The shape of the reinforcing portion 34 has approximately the same shape as the light shielding portion 33, and three reinforcing portion-side protrusions 35b to 35b having the same shape are disposed at the same positions as those of the three light-shielding member-side protrusions 35a to 35a. In the reinforcing portion 34, differences between the reinforcing portion 34 and the light shielding portion 33 are that the strength of the reinforcing portion 34 is higher than that of the light shielding portion 33, the inner diameter of the reinforcing portion 34 is larger than that of the light shielding portion 33, and the reinforcing portion is divided into four in the circumferential direction.

The reason for configuring the inner diameter of the reinforcing portion 34 to be large is that the inner circumferential edge of the reinforcing portion 34 is not in contact with the outer circumferential face of the decorative ring A23. In addition, the reason for dividing the reinforcing portion 34 into four is that the reinforcing portion 34 can be expanded to the outer side in the radial direction in accordance with the press-in force at the time of assembling the light shielding member 30 based on the configuration in which the strength of the reinforcing portion 34 is higher than that of the light shielding portion 33. Accordingly, the number of divisions of the reinforcing portion 34 may not be divided into four but be divided into two, three, five or more. The four division parts 34a to 34d of the reinforcing portion 34 and the light shielding portion 33 are fixed through an adhesive, a thermal welding, or the like so as to be integrally configured.

It is most preferable that polyethylene terephthalate (PET) is used as the material for the division parts 34a to 34d. However, the material for the division parts 34a to 34d is not limited PET, and it is apparent that polyethylene (PE), polypropylene (PP), or other plastic may be used. Furthermore, as the material for the division parts 34a to 34d, rubber, metal, or the like other than plastic may be used.

The three light shielding member-side convex portions 35 to 35 of the light shielding member 30 are configured by the three light shielding member-side protrusions 35a to 35a of the light shielding portion 33 and the three reinforcing portion-side protrusions 35b to 35b of the reinforcing portion 34. In this embodiment, the light shielding member-side convex portions 35 are formed as protrusions that respectively forms an approximate square and are arranged so as to be equally spaced (120 degrees) in the circumferential direction. However, the three light shielding member-side convex portions 35 to 35 may be configured to be arranged so as to be bilaterally symmetrical or may be configured to be arranged so as to be unequally spaced in the circumferential direction. Furthermore, the number of the light shielding member-side convex portions 35 is not limited to that described in this embodiment and may be configured to be one, two, four, or more. In other words, by configuring at least one light shielding member-side convex portion 35, the advantages according to this embodiment of the present disclosure can be acquired.

As illustrated in FIGS. 1, 2, 5, and the like, on the cross-section of the cam ring 5 that is located on the subject side, three lens barrel-side concave portions 36 to 36 are disposed in correspondence with the three light shielding member-side convex portions 35 to 35 of the light shielding member 30. The three lens barrel-side concave portions 36 to 36 are arranged to as to be equally spaced in the circumferential direction on the cross-section of the cam ring 5 that forms a ring shape and are formed as grooves radially extending in the radial direction. The width of the lens barrel-side concave portion 36 is formed so as to be slightly larger than that of the light shielding member-side convex portion 35, and the light shielding member-side convex portion 35 is configured so as to be guided by the lens barrel-side concave portion 36 and to be movable to the outer side and the inner side in the radial direction.

The light shielding member 30 having such a configuration is fitted to the decorative ring A23 in a state of being slightly pressed thereto. In this example, a hole of the light shielding member 30 is fitted with the decorative ring A23 from the reinforcing portion 34 side, and the cross-section of the reinforcing portion 34 is configured so as to be brought into contact with the cross-section of the linear motion ring 6. At this time, the three light shielding member-side convex portions 35 to 35 of the light shielding member 30 are brought into contact with the three lens barrel-side concave portions 36 to 36 arranged on the cross-section of the cam ring 5 so as to be slidable, and the inner circumferential edge of the light shielding portion 33 is brought into contact with the outer circumferential face of the decorative ring A23 so as to be slidable. This light shielding member 30 is held in a state of being movable to a predetermined position by the cross-sectional part 24b of the decorative ring 24 mounted in the cam ring 5 and is prevented from dropping out of the predetermined position.

Accordingly, the light shielding member 30, with the optical axis CL of the optical axis used as its center, is integrally moved by the cam ring 5 in the direction of the optical axis and is driven to be integrally moved in the direction of rotation by the cam ring 5. On the other hand, in a direction perpendicular to the optical axis CL, that is, in the radial direction, the light shielding member 30 can be independently moved as a body separated from the cam ring 5.

When the cam ring 5 representing a first lens barrel according to an embodiment is driven to rotate so as to expand or contract the retractable lens device 1 having the above-described configuration, the light shielding member 30 is driven to rotate around the optical axis CL integrally with the cam ring 5 and moves in the direction of the optical axis. Simultaneously with this operation, the first group frame 7 representing a second lens barrel according to an embodiment moves linearly in the direction of the optical axis in accordance with the amount of rotation of the cam ring 5, and the decorative ring A moves in the direction of the optical axis CL integrally with the first group frame 7. At this time, the light shielding member 30 arranged in front of the cam ring 5 is fitted with the decorative ring A in a state of slightly being pressed therein, and accordingly, the inner circumferential edge of the light shielding portion 33 of the light shielding member 30 is slidably in contact with the outer circumferential face of the decorative ring A23 in a state of being tightly brought into contact therewith.

It is necessary to bring the light shielding portion 33 and the decorative ring A23 into tight contact with each other in consideration of the light shielding property of the lens barrel. However, for example, in a case where the light shielding member 30 is disposed to be eccentrically disposed with respect to the optical axis CL, the sliding frictional force increases in the eccentric portion, and the rotation load increases, and the rubbing sound increases so as to be heard as a noise. Regarding this point, in a device in the related art, the light shielding member is fixed to the cam ring by using an adhesive, and it is difficult to decrease the sliding frictional force, and accordingly, there is a problem in that a noise is generated at the time of expanding or contracting the retractable lens device 1.

In contrast to this, according to the embodiment of the present disclosure, although the light shielding member 30 is integrally configured with the cam ring 5 and the linear motion ring 6 in the direction of the optical axis and the direction of rotation around the optical axis CL, the light shielding member 30 is configured so as to be movable by a small distance in the direction perpendicular to the optical axis. Accordingly, for example, in a case where the light shielding member 30 is eccentrically disposed with respect to the optical axis CL, and the sliding frictional force consequently increases in the eccentric portion, the light shielding member 30 is pressed to the outer side in the radial direction by the sliding frictional force. Therefore, since the light shielding member 30 moves in a direction decreasing the amount of eccentricity, the generation of a noise such as the rubbing sound that is generated when the light shielding portion 33 and the decorative ring A23 are slidably in contact with each other can be decreased.

Particularly, in this embodiment, while the light shielding member 30 and the cam ring 5 integrally rotate around the optical axis CL, the decorative ring A23 moves linearly in the direction of the optical axis integrally with the linear motion ring 6. Accordingly, by allowing the inner circumferential edge of the light shielding portion 33 to follow the cancavo-convex of the outer circumferential face of the decorative ring A23, the vibration generated when the light shielding member 30 formed from a rubber sheet moves over the concavo-convex decreases, whereby a noise such as a rubbing sound can be reduced.

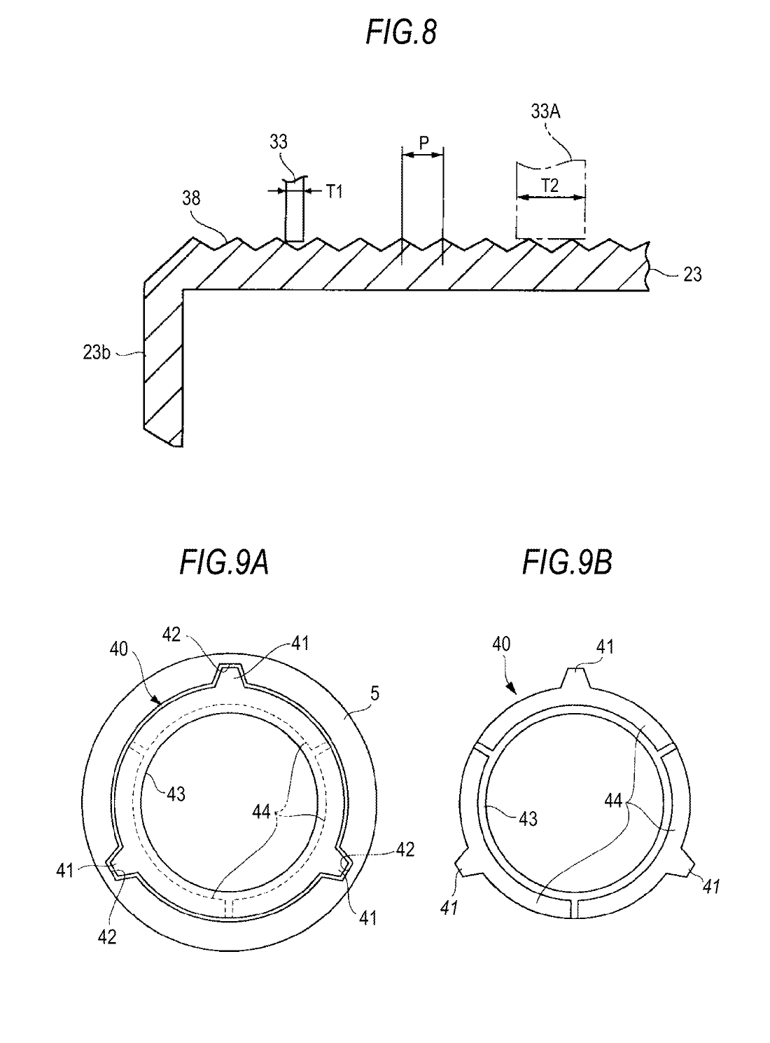

FIG. 8 illustrates main portions of the inner circumferential edge of the light shielding portion 33 and the outer circumferential face of the decorative ring A23 in an enlarged scale. Generally, an aluminum alloy is used as the material for the decorative rings A23 to C25 used in the retractable lens device 1 owing to the excellency of its appearance as the external shape and the like, and the surfaces of the other circumferential faces are processed by a machine tool such as a lathe. Accordingly, on the outer circumferential face of the decorative ring A23, a concavo-convex (sliding convex portion) 38, which has a screw groove shape, extending in a spiral shape is present, and the decorative ring 23A having the concavo-convex 38 moves linearly in the direction of the optical axis. In contrast to this, according to the embodiment of the present disclosure, the light shielding member 30 is configured so as to slide at a tilt. Accordingly, the vibration generated when the light shielding member 30 moves over the spiral concavo-convex 38 of the decorative ring A23 is effectively decreased, and the generation of a rubbing sound can be suppressed or prevented.

In FIG. 8, a light shielding portion 33 denoted by a solid line represents a case where the thickness T1 of the light shielding portion 33 is configured to be smaller than the pitch P of the concavo-convex 38, and a light shielding portion 33A denoted by a dashed-dotted line represents a case where the thickness T2 of the light shielding portion 33A is configured to be larger than the pitch P of the concavo-convex 38. In any of the above-described cases, according to the embodiment of the present disclosure, the rubbing sound can be effectively decreased while securing a high light shielding property. In addition, the concavo-convex arranged on the outer circumferential face of the decorative ring A23 is not limited to have a spiral shape, and may have a circular groove shape that is continuous around 360 degrees in the circumferential direction. Furthermore, the cross-sectional shape of the concavo-convex is not limited to a triangular shape and may be a semi-circular shape, a “U” shape, an inverted trapezoidal shape, or any of other various shapes.

In addition, in this embodiment, although an example has been described in which the light shielding member 30 is configured by a combination of the light shielding portion 33 and the reinforcing portion 34, a light shielding member according to an embodiment of the present disclosure may be configured only by the light shielding portion without the reinforcing portion. The configuration of the light shielding member at that time, for example, may be realized by forming the structure illustrated in FIG. 6 and FIGS. 7A and 7B only by using the light shielding portion. It is apparent that the light shielding member of such a case is not limited to have the shape illustrated in the figures.

FIGS. 9A to 14B illustrate a light shielding member of a retractable lens device 1 according to another embodiment of the present disclosure. FIGS. 9A and 9B illustrate a light shielding member according a second embodiment. A difference between the light shielding member 40 and the above-described light shielding member 30 according to the first embodiment is that the tip end sides of three light shielding member-side convex portions 41 are formed to be thin so as to be formed as a tapered shape in the light shielding member 40. The light shielding member-side convex portion 41 is configured by forming side faces on both sides in the circumferential direction in a tapered shape to be tapers. In correspondence with the shape of the three light shielding member-side convex portions 41 of the light shielding member 40, three lens barrel-side concave portions 42 having a shape corresponding to the shape of the light shielding member 40 are arranged on the cross-section of the cam ring 5.

The light shielding member 40 is configured by a light shielding portion 43 and a reinforcing portion 44. The reinforcing portion 44 is formed by a combination of three division parts, and the three division parts have the same shape. In other words, the division part of the reinforcing portion 44 includes an arc shape portion that is continuous around less than 120 degrees in the circumferential direction and a reinforcing-side protrusion that is formed so as to protrude to the outer side in the radial direction at the middle portion of the arc-shaped portion in the circumferential direction. The other configurations are the same as those of the light shielding member 30 according to the first embodiment. Even in a case where the light shielding member 40 is used, advantages similar to those of a case where the light shielding member 30 is used can be acquired. Particularly, in the second embodiment, the light shielding member-side convex portion 41 is formed in a tapered shape in which the outer side thereof in the radial direction is formed to be thin. Accordingly, when the light shielding member 40 moves in the radial direction, the light shielding member-side convex portion 41 located at the moved side is engaged with the lens barrel 0 side concave portion 42. Therefore, the strength of the engagement between the light shielding member-side convex portion 41 and the barrel-side concave portion 42 of the lens barrel increases, whereby the rotational force of the cam ring 5 can be reliably transferred to the light shielding member 40.

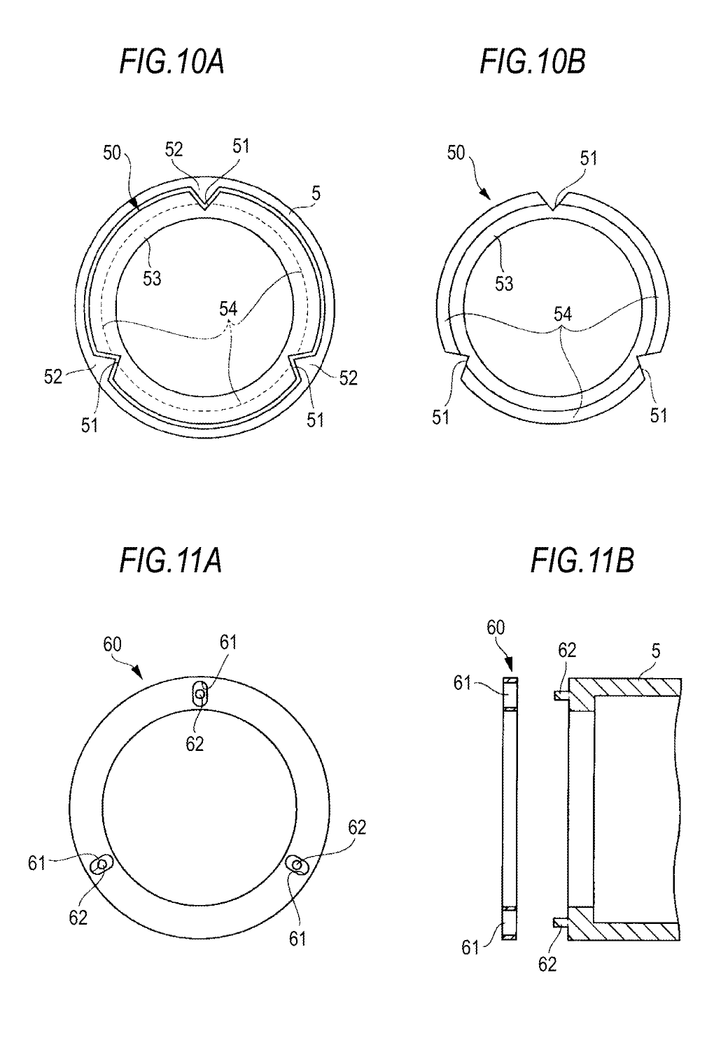

FIGS. 10A to 10B illustrate a light shielding member according to a third embodiment. A difference between this light shielding member 50 and the above-described light shielding member 30 according to the first embodiment is that the light shielding member-side concave portions are replaced, and three light shielding member-side concave portions 51 to 51 are formed. The light shielding member-side concave portion 51 is configured as a “V” shaped notch that is open toward the outer side in the radial direction. In correspondence with the shape of the three light shielding member-side concave portions 51 of the light shielding member 50, three lens barrel-side convex portions 52 having a shape corresponding to the light shielding member 50 are arranged on the cross-section of the cam ring 5.

The light shielding member 50 is configured by a light shielding portion 53 and a reinforcing portion 54. The reinforcing portion 54 is formed by a combination of three division parts, and the three division parts have the same shape. In other words, the division part of the reinforcing portion 54 has an arc shape that is continuous around less than 120 degrees in the circumferential direction. The other configurations are similar to those of the light shielding member 30 according to the first embodiment, and both the light shielding member 40 and the light shielding member 50 can be slightly moved in the diameter direction.

By using this light shielding member 50, advantages similar to those of a case where the light shielding member 30 is used can be acquired. Particularly, in the case of a third embodiment, the light shielding member-side concave portion 51 is formed in a “V” shape that opens toward the outer side in the radial direction. Thus, when the light shielding member 50 moves in the radial direction, the light shielding member-side concave portion 51 located at the movement side is engaged with the lens barrel-side convex portion 52. Accordingly, it is possible to increase the strength of the engagement between the light shielding member-side concave portion 51 and the lens barrel-side convex portion 52, whereby the rotation force of the cam ring 5 can be reliably transferred to the light shielding member 50.

FIGS. 11A and 11B illustrate a light shielding member according to a fourth embodiment. Differences between this light shielding member 60 and the light shielding member 30 according to the first embodiment are that the light shielding member 60 is configured only by the light shielding portion without the reinforcing portion, the light shielding member-side convex portion is eliminated, and three long holes are formed as three light shielding member-side concave portions 61 to 61 in the light shielding member 60 according to the fourth embodiment. The three long holes 61 to 61 are arranged open so as to be equally spaced in the circumferential direction and are formed as holes longer than the lens barrel-side convex portion 62. In correspondence with the shapes of the three light shielding member-side convex portions 61 to 61 of this light shielding member 60, three protrusions engaged with the three long holes 61 to 61 are formed at positions facing the cross-section of the cam ring 5 as a specific example of the lens barrel-side convex portions 62.

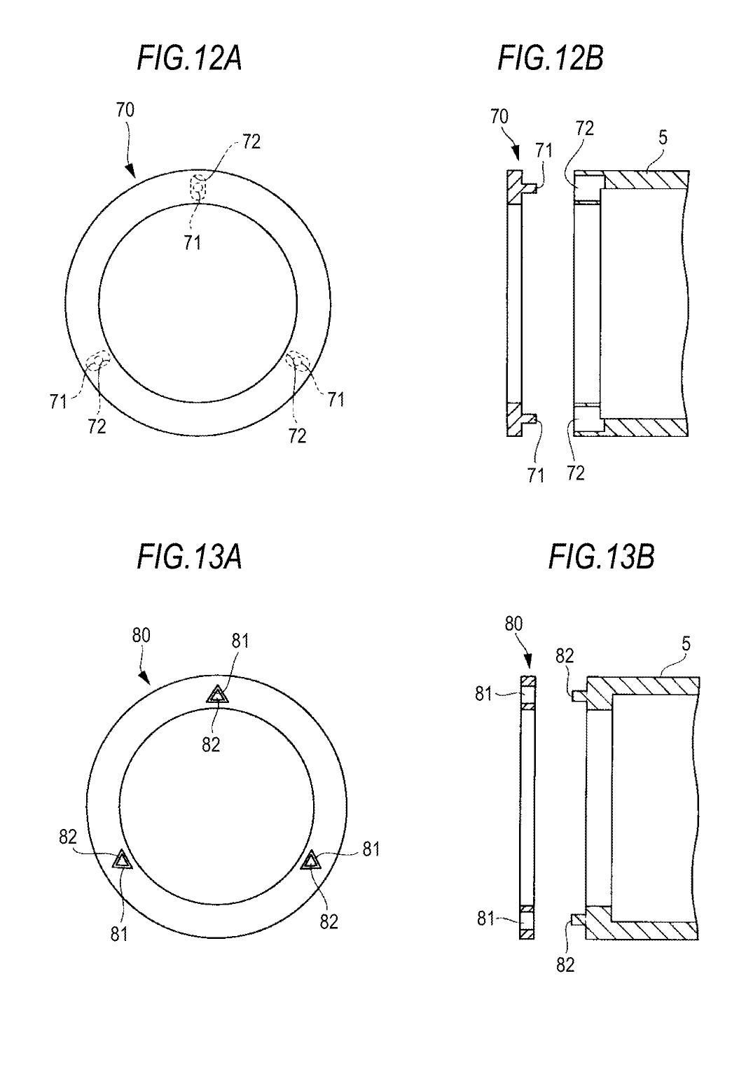

FIGS. 12A and 12B illustrate a light shielding member according to a fifth embodiment. Differences between this light shielding member 70 and the light shielding member 60 according to the fourth embodiment are that the portions and the long holes are set on opposite sides, protrusions are arranged in the light shielding member 70 so as to be configured as light shielding member-side convex portions 71 in the light shielding member 70. The three light shielding member-side convex portions 71 to 71 formed from protrusions are arranged open so as to be equally spaced in the circumferential direction. In correspondence with the shape of the three light shielding member-side convex portions 71 to 71 of this light shielding member 70, three long holes are formed at positions facing the cross-section of the cam ring 5 as a specific example of the lens barrel-side concave portions 72. The three lens barrel-side concave portions 72 to 72 are arranged open so as to be equally spaced in the circumferential direction and are configured as holes longer than the light shielding member-side convex portions 71.

The other configurations are similar to those of the light shielding member 30 according to the first embodiment, and the light shielding member 60 and the light shielding member 70 can be slightly moved in the diameter direction. By configuring the light shielding member to be the same as the light shielding member 60 according to the fourth embodiment or the light shielding member 70 according to the fifth embodiment, advantages similar to those of the light shielding member 30 according to the first embodiment or the like can be acquired.

FIGS. 13A and 13B illustrate a light shielding member according to a sixth embodiment. A difference between this light shielding member 80 and the light shielding member 60 according to the fourth embodiment is that the light shielding member-side concave portions are formed as triangular holes in the light shielding member 80. The three light shielding member-side concave portions 81 to 81 formed as triangular holes are arranged such that the inner side in the radial direction is configured as a base, and the outer side in the radial direction has a sharp shape, and are disposed open so as to be equally spaced in the circumferential direction. In correspondence with the shape of the three light shielding member-side concave portions 81 to 81 of this light shielding member 80, protrusions forming three triangular prisms are formed as a specific example of the lens barrel-side convex portions 82 at positions opposing the cross-section of the cam ring 5. The lens barrel-side convex portion 82 is formed so as to be a similar figure of the light shielding member-side concave portion 81. The three lens barrel-side convex portions 82 to 82 are arranged open so as to be equally spaced in the circumferential direction, and the light shielding member 80 is configured so as to be slightly movable in the diameter direction.

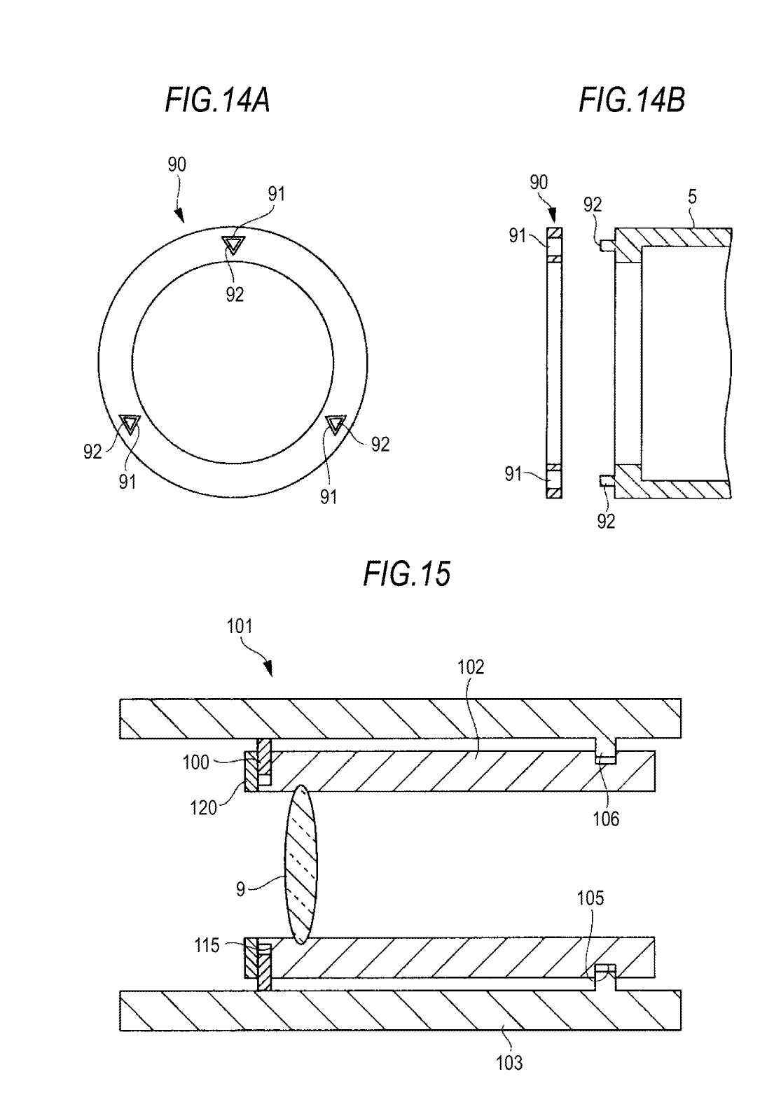

FIGS. 14A and 14B illustrate a light shielding member according to a seventh embodiment. A difference between this light shielding member 90 and the light shielding member 80 according to the sixth embodiment is that the direction of the light shielding member-side concave portions formed as triangular holes is configured in the opposite direction in the light shielding member 90. The three light shielding member-side concave portions 91 to 91 are arranged such that the outer side in the radial direction is configured as a base and are arranged open so as to be equally spaced in the circumferential direction. In correspondence with the shape of the three light shielding member-side concave portions 91 to 91 of this light shielding member 90, protrusions forming three triangular prisms are formed as a specific example of the lens barrel-side convex portions 92 at positions opposing the cross-section of the cam ring 5. The lens barrel-side convex portion 92 is formed so as to be a similar figure of the light shielding member-side concave portion 91. The three lens barrel-side convex portions 92 to 92 are arranged open so as to be equally spaced in the circumferential direction, and the light shielding member 90 is configured so as to be slightly movable in the diameter direction.

By configuring the light shielding member to be the same as the light shielding member 80 according to the sixth embodiment or the light shielding member 90 according to the seventh embodiment, advantages similar to those of the light shielding member 30 according to the first embodiment or the like can be acquired. In addition, the shapes of the light shielding member-side convex portions, the light shielding member-side concave portions, and the lens barrel-side concave portions, the lens barrel-side convex portions are not limited to those of the above-described embodiments, and it is apparent that an arbitrary combination of the above-described embodiments or known shapes can be used.

FIG. 15 is a schematic diagram illustrating a schematic configuration of a lens barrel device according to a second embodiment of the present disclosure. In the lens barrel device 101 according to this embodiment, a light shielding member 100 is supported by an inner lens barrel 102 representing a first lens barrel according to the second embodiment, and the outer circumference on the light shielding side is configured so as to be slid on the inner circumferential face of an outer lens barrel 103 representing a second lens barrel according to the second embodiment with being in contact therewith. The outer lens barrel 103 can relatively rotate with respect to the inner lens barrel 102 and is configured so as to be movable in the direction of the optical axis as an axial direction. In the embodiment illustrated in the figure, a guide groove 105 having a spiral shape is arranged on the outer circumferential face of the inner lens barrel 102, and a guide pin 106 that is slidably engaged with the guide groove 105 is disposed in the outer lens barrel 103. Through the engagement between the guide pin 106 and the guide groove 105, the inner lens barrel 102 and the outer lens barrel 103 can move relatively with respect to each other and can move in the direction of the optical axis.

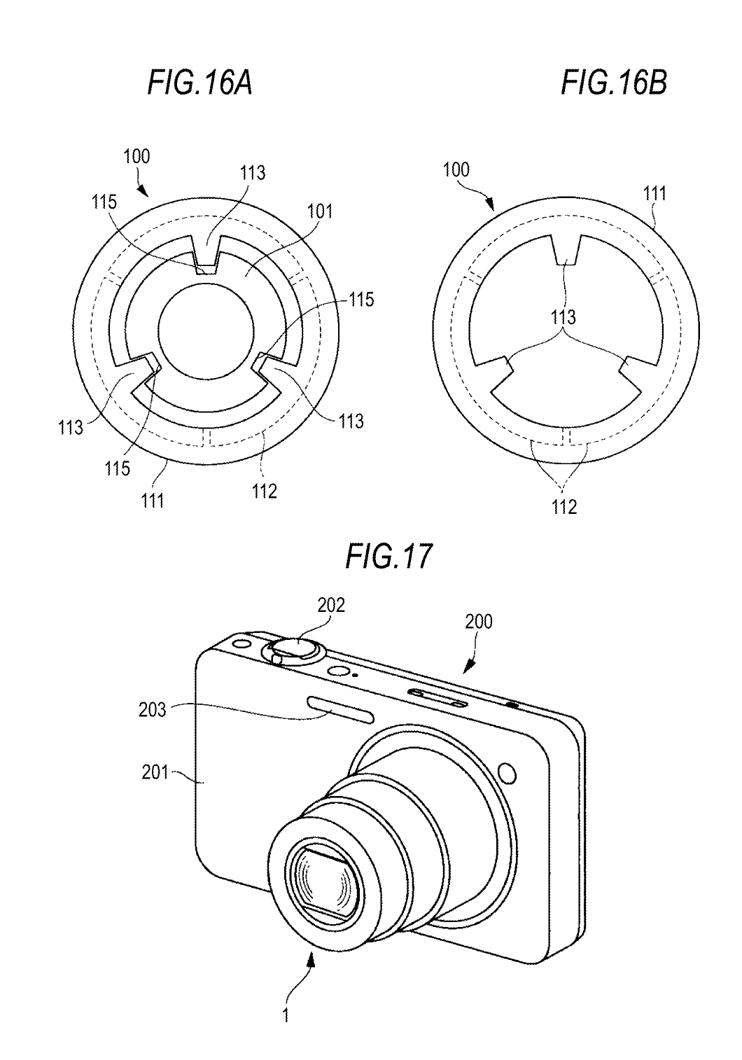

The light shielding member 100 has a configuration as illustrated in FIGS. 16A and 16B. In other words, the light shielding member 100 is configured by a light shielding portion 111 and a reinforcing portion 112. The shielding portion 111 is formed in a ring shape by an elastic member such as rubber that can be easily elastically transformed so as to be expanded or contracted. At three positions on the inner circumferential edge of the light shielding portion 111, three light shielding member-side protrusions protruding to the inner side in the radial direction are disposed.

The outer diameter of the light shielding portion 111 of the light shielding member 100 is formed to have a diameter slightly larger than the inner diameter of the outer lens barrel 103. Accordingly, the outer circumference of the light shielding portion 111 is configured so as to be brought into contact with the inner circumferential face of the outer lens barrel 103 in a state of being slightly pressed thereto. In addition, the inner diameter of the light shielding portion 111 is formed so as to have a diameter smaller than the outer diameter of the inner lens barrel 102. The diameter of a circle binding the tip ends of the three light shielding member-side protrusions is formed so as to have a diameter that is slightly larger than the inner diameter of the inner lens barrel 102.

The reinforcing portion 112 of the light shielding member 100 is configured by a combination of three division parts acquired by dividing the light shielding portion 111 into three in the circumferential direction. The shape of the reinforcing portion 112 acquired by combining the three division parts is approximately the same as that of the light shielding portion 111, and three reinforcing portion-side protrusions having the same shape are disposed at the same positions as those of the three light shielding member-side protrusions. Differences between this reinforcing portion 112 and the light shielding portion 111 are that the strength of the reinforcing portion 112 is formed to be higher than that of the light shielding portion 111, the outer diameter of the reinforcing portion 112 is smaller than the outer diameter of the light shielding portion 111, and the reinforcing portion 112 is divided into three in the circumferential direction. In other words, the division part of the reinforcing portion 112 has an arc portion that is continuous around less than 120 degrees in the circumferential direction. In a middle portion in the circumferential direction that is located on the inner side of each division part, a reinforcing portion-side protrusion protruding toward the inner side in the radial direction is formed.

The light shielding member-side convex portion of the light shielding member 100 is configured by the three reinforcing portion-side protrusions of the reinforcing portion 112 and the three light shielding member-side protrusions 113 of the light shielding portion 111. The other configurations are the same as those of the light shielding member 30 according to the first embodiment or the like.

In correspondence with the shape of the light shielding member 100, three lens-barrel-side concave portions 115 to 115 having a shape corresponding to the shape of the three light shielding member-side convex portions 113 to 113 are disposed on the cross-section of the inner lens barrel 102 that is located on the subject side. The three lens barrel-side concave portions 115 to 115 are arranged so as to be equally spaced in the circumferential direction on the cross-sectional part, which forms a ring shape, of the inner lens barrel 102 that is located on the subject side and are formed as notches open toward the outer side in the radial direction. The width of the lens barrel-side concave portion 115 is formed so as to be slightly larger than the width of the light shielding member-side convex portion 113, and the light shielding member-side convex portion 113 is configured to be guided by the lens barrel-side concave portion 115 so as to be movable to the outer side and the inner side in the radial direction.

The light shielding member 100 having such a configuration is attached by being mounted to the cross-sectional part of the inner lens barrel 102 that is located on the subject side. On the cross-sectional part of the inner lens barrel 102, a light shielding member locking plate 120 is mounted, and the light shielding member 100 is prevented from being taken out by the light shielding member locking plate 120. The light shielding member 100 in the state of being mounted to the inner lens barrel 102 is fitted into the outer lens barrel 103 in a state of being slightly being pressed therein. By configuring as such, advantages similar to those of the above-described first embodiment can be acquired. In other words, the sliding frictional force at the time of the relative movement of both lens barrels can be decreased while a gap between the inner lens barrel 102 and the outer lens barrel 103 is light-shielded in a reliable manner by the light shielding member 100.

FIG. 17 illustrates a digital camera 200 as an imaging apparatus, which uses the above-described retractable lens device 1, according to an embodiment. This digital camera 200 is configured so as to include a case 201 that configures the exterior thereof and a retractable lens device 1 that is mounted to the case 201. At a position located on the right portion of a front face of the case 201, the retractable lens device 1 in which an imaging optical system is built is disposed. FIG. 17 illustrates a use status (a wide-angle position, a distant position, and a middle position between the wide-angle position and the distant position) in which the retractable lens device 1 is expanded. From this status, by forming a retracted state (housing position) by retreating the retractable lens device 1, the front face of the case 201 and the front face of the retractable lens device 1 are configured to be approximately the same plane.

On a side opposite to the retractable lens device 1 that is on the top face of the case 201, a shutter button 202 is disposed. In an upper portion of the front face of the case 201, a flash unit 203 that emits a flash of a flash device is disposed. In addition, on the rear face of the case 201 that is not illustrated in the figure, a display used for displaying a captured image or an operation function and a plurality of operation switches used for turning power on/off, switching among a photographing mode, a reproduction mode, or the like, or the other operations are disposed. Furthermore, inside the case 201, an image processing unit that generates image data based on an imaging signal output from an imaging device and records the image data on a storage medium such as a memory card, a display processing unit that displays the image data on the display, a control unit, and the like are arranged. The control unit includes a CPU that controls the image processing unit, the display processing unit, a driving unit, and the like in accordance with an operation of the operation switch or the shutter button 202.

By using the retractable lens device 1 or the like in the digital camera 200 having such a configuration, an expanding or retreating operation can be easily performed by decreasing the operation load, and the generation of a rubbing sound that is generated at the time of the operation can be decreased. Accordingly, the entire apparatus can be miniaturized by reducing the power source of the retractable lens device 1, and generation of a noise can be suppressed or prevented by reducing the generation of the rubbing sound.

Although the description has been presented as above, the present disclosure is not limited to the above-described embodiments, and various changes in the form can be made within the range not departing from the concept of the present disclosure. For example, in the above-described embodiments, although an example in which the present disclosure is applied to a digital camera has been described, the present disclosure can be applied to a monitoring camera, an in-vehicle camera, a video phone, or a camera for a personal computer, or other kinds of imaging apparatuses.

The present disclosure contains subject matter related to that disclosed in Japanese Priority Patent Application JP 2010-268742 filed in the Japan Patent Office on Dec. 1, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A lens barrel device that configures a lens barrel supporting an optical system, the lens barrel device comprising:
a first lens barrel;
a second lens barrel that moves in a direction of an optical axis with respect to the first lens barrel in accordance with rotation of the first lens barrel around the optical axis of the optical system; and
a light shielding member that is disposed so as to block a gap between the second lens barrel and the first lens barrel,
wherein the light shielding member is formed by an elastic member and has one or more light shielding member-side convex portions or light shielding member-side concave portions, which can be engaged with a lens barrel-side concave portion or a lens barrel-side convex portion that is disposed in the first lens barrel, disposed therein, and
wherein, through engagement between the one or more light shielding member-side convex portions or the light shielding member-side concave portions and the lens barrel-side concave portion or the lens barrel-side convex portion, the light shielding member can move with respect to the first lens barrel in a direction perpendicular to the optical axis of the optical system and is linked with the first lens barrel in a direction of rotation around the optical axis.

2. The lens barrel device according to claim 1,
wherein the light shielding member includes a light shielding portion that is formed by an elastic member, which forms a ring shape, that is slidably brought into contact with the second lens barrel and a reinforcing portion that is engaged with the first lens barrel by using the one or more light shielding member-side convex portions or light shielding member-side concave portions, and
wherein the light shielding member is integrally formed by bonding the light shielding portion and the reinforcing portion together.

3. The lens barrel device according to claim 2, wherein the reinforcing portion is formed by a member, which is continuous in a circumferential direction, as one body.

4. The lens barrel device according to claim 2, wherein the reinforcing portion is formed by a plurality of division parts that are parts divided into multiple parts in a circumferential direction.

5. The lens barrel device according to claim 4, wherein the plurality of divisions are formed from two or three or more similar members formed in an arc shape.

6. The lens barrel device according to claim 2, wherein the reinforcing portion is harder than the light shielding portion.

7. The lens barrel device according to claim 1,
wherein the one or more light shielding member-side convex portions are formed by protrusion parts that protrude to an outer side in a radial direction or an inner side in the radial direction, and
wherein the protrusion parts have tip end sides that are formed thin so as to be formed in tapered shapes.

8. The lens barrel device according to claim 1, wherein a sliding contact portion that extends in a direction approximately intersecting the optical axis of the optical system is disposed on a contact face of the second lens barrel with which the light shielding member is slidably brought into contact.

9. The lens barrel device according to claim 8, wherein a thickness of the light shielding portion is smaller than a pitch of the sliding convex portion in the direction of the optical axis, and the light shielding portion overlaps the sliding convex portion when viewed from the direction of the optical axis.

10. The lens barrel device according to claim 1, wherein the first lens barrel is positioned to an outer side of the second lens barrel.

11. An imaging apparatus comprising:
a lens barrel device which includes a plurality of lens barrels, in which an optical system is arranged, and the plurality of lens barrels are housed as a nested type so as to be able to move relatively in an axial direction; and
an imaging apparatus main body to which the lens barrel device is attached,
wherein the lens barrel device includes
a first lens barrel,
a second lens barrel that moves in a direction of an optical axis with respect to the first lens barrel in accordance with rotation of the first lens barrel around the optical axis of the optical system, and
a light shielding member that is disposed so as to block a gap between the second lens barrel and the first lens barrel,
wherein the light shielding member is formed by an elastic member and has one or more light shielding member-side convex portions or light shielding member-side concave portions, which can be engaged with a lens barrel-side concave portion or a lens barrel-side convex portion that is disposed in the first lens barrel, disposed therein, and
wherein, through engagement between the one or more light shielding member-side convex portions or the light shielding member-side concave portions and the lens barrel-side concave portion or the lens barrel-side convex portion, the light shielding member can move with respect to the first lens barrel in a direction perpendicular to the optical axis of the optical system and is linked with the first lens barrel in a direction of rotation around the optical axis.
